(19) United States
(12) Patent Application Publication
(10) Pub. No.: US 2013/0322590 A1
(43) Pub. Date: Dec. 5, 2013

(54) EXTENSION OF METHODS TO UTILIZE FULLY CERAMIC MICRO-ENCAPSULATED FUEL IN LIGHT WATER REACTORS

(71) Applicants: Francesco Venneri, Los Alamos, NM (US); Won Jae Lee, Taejon (KR)

(72) Inventors: Francesco Venneri, Los Alamos, NM (US); Won Jae Lee, Taejon (KR)

(21) Appl. No.: 13/681,067

(22) Filed: Nov. 19, 2012

Related U.S. Application Data
(60) Provisional application No. 61/561,829, filed on Nov. 19, 2011.

(51) Int. Cl. G21C 3/07; G21C 3/32

(52) U.S. Cl. CPC G21C 3/07; G21C 3/32
USPC 376/419; 376/412; 376/434

(57) ABSTRACT

A 12×12 fully ceramic micro-encapsulated fuel assembly for a light water nuclear reactor includes a set of FCM fuel rods bundled in a square matrix arrangement. The fully ceramic micro-encapsulated fuel is comprised of tristructural-isotropic particles. Each tristructural-isotropic particle has a kernel that is comprised uranium nitride. The kernel diameter is 400 or more micrometers. The fully ceramic micro-encapsulated fuel is further mixed with a burnable poison material.

### CROSS REFERENCE TO RELATED APPLICATIONS

This application claims the benefit and priority of U.S. Patent Application No. 61/561,829, entitled “EXTENSION OF METHODS TO UTILIZE FULLY CERAMIC MICRO-ENCAPSULATED FUEL IN LWRS,” filed Nov. 19, 2011, which is hereby incorporated by reference in its entirety. Furthermore, this application is related to a U.S. patent application Ser. No. 13/567,243, entitled “DISPERSION CERAMIC MICRO-ENCAPSULATED (DCM) NUCLEAR FUEL AND RELATED METHODS,” filed Aug. 6, 2012, which is hereby incorporated by reference. This application is also related to a U.S. patent application Ser. No. 13/669,200, entitled “FULLY CERAMIC MICROENCAPSULATED REPLACEMENT FUEL ASSEMBLIES FOR LIGHT WATER RETACTORS,” filed Nov. 5, 2012, which is hereby incorporated by reference.

### FIELD OF THE DISCLOSURE

The present invention relates generally to nuclear technologies, and more particularly relates to a fully ceramic micro-encapsulated fuel pellet and a fully ceramic micro-encapsulated fuel assembly with reactivity characteristics that are comparable to a standard reference reactor fuel for light water reactors.

### DESCRIPTION OF BACKGROUND

Nuclear fuel undergoes fission to produce energy in a nuclear reactor, and is a very high-density energy source. Oxide fuels such as uranium dioxide are commonly used in today's reactors because they are relatively simple and inexpensive to manufacture, can achieve high effective uranium densities, have a high melting point, and are inert to air. They also provide well-established pathways to reprocessing. For example, solid uranium dioxide (“UO₂”) is widely used in light water reactors (“LWRs”). To be used as LWR fuel, uranium dioxide powder is compacted into cylindrical pellets and sintered at high temperatures to produce ceramic nuclear fuel pellets with a high density. Such fuel pellets are then stacked into metallic tubes (“cladding”). Cladding prevents radioactive fission fragments from escaping from the fuel into the coolant and contaminating it. The metal used for the tubes depends on the design of the reactor. Stainless steel was used in the past, but most reactors now use a zirconium alloy which, in addition to being highly corrosion-resistant, has low neutron absorption. The use of zirconium instead of stainless steel allows lower enrichment fuel to be used for similar operating cycles.

The sealed tubes containing the fuel pellets are termed fuel rods, which are grouped into fuel assemblies used to build up the core of a nuclear power reactor. Each fuel assembly includes fuel rods bundled in an arrangement of 16×16 or 17×17 in current Pressurized Water Reactors (“PWRs”) depending on the reactor core design. A reactor core includes multiple fuel assemblies, such as 400 to 800 fuel assemblies.

Micro-encapsulated tristructural-isotropic (“TRISO”) fuel particles compacted within a graphite matrix have been developed for a new generation of gas-cooled reactors. A TRISO fuel particle comprises a kernel of fissile/fertile material coated with several isotropic layers of pyrolytic carbon (“PyC”) and silicon carbide (“SiC”). These TRISO particles are combined with a graphite matrix material and pressed into a specific shape. In one embodiment, a TRISO particle comprises a kernel, a buffer layer, an inner pyrolytic carbon (“PyC”) layer, a SiC coating layer, and an outer PyC layer, as more fully set forth in U.S. application Ser. No. 13/567,243, which was previously incorporated by reference. The TRISO particle kernel may comprise fissile and/or fertile materials (e.g., uranium, plutonium, thorium, etc.) in an oxide, carbide, or oxycarbide form. In one exemplary embodiment, the TRISO particle kernel may comprise low enriched uranium (“LEU”) of any suitable enrichment level. The TRISO fuel forms offer much better fission product retention at higher temperatures and burnup than metallic or solid oxide fuel forms, such as the solid oxide fuel used in present day Light Water Reactors (“LWRs”).

Burnup is a measure of how much energy is extracted from a nuclear fuel source. It is measured as the fraction of fuel atoms that underwent fission in fissions per initial metal atom (“FIMA”). Burnup is also measured as the actual energy released per mass of initial fuel in, for example, megawatt-days/kilogram of heavy metal (“MWd/kgHM”). Higher burnup may not only reduce the overall waste volume but also limit possible nuclear proliferation and diversion opportunities. While high burnup is desirable, it is also important that burnup rates for the replacement TRISO based fuel should be not too fast and should at least match the burnup rate of the reference standard fuel, in order to achieve comparable service life in the reactor.

Recently, fully ceramic micro-encapsulated (“FCM”) fuel has been proposed for LWRs and in particular PWRs FCM fuel utilizes TRISO fuel particles, which are pressed into compacts using SiC matrix material and loaded into fuel pins. However, the heavy metal mass in a FCM fuel pellet tends to be considerably lower than that of a conventional solid fuel pellet due to the limited space available for heavy metal and fissile mass inside TRISO particles of FCM fuel. The heavy metal and fissile mass in a FCM fuel pellet can be increased, as more fully set forth in U.S. application Ser. No. 13/669,200, by increasing the diameter of the FCM fuel pellet or the kernel diameter (“KD”) of TRISO particles within the FCM fuel pellet or the packing fraction of the TRISO particles, or using a high density material in the kernel, such as Uranium Nitride or Uranium Silicide. Under the first approach, for example, 12×12 FCM fuel assemblies replace conventional 16×16 solid fuel assemblies and 13×13 FCM fuel assemblies replace conventional 17×17 solid fuel assemblies. Under the latter approach, the kernel diameter of TRISO particles can be increased to, for example, 400 μm, 500 μm, 600 μm, 700 μm, or 800 μm.

The reactivity characteristics of a FCM fuel replacement assembly depends on the type(s) of material comprising the kernel of TRISO particles. Accordingly, there exists a need for a FCM fuel assembly with reactivity characteristics that are comparable to or better than that of a standard reference reactor fuel assembly, such as the widely used solid UO₂ assembly.

### OBJECTS OF THE DISCLOSED SYSTEM, METHOD, AND APPARATUS

An object of the tristructural-isotropic (“TRISO”) particles is to provide greater safety during operations and in accident situations, relative to standard reference fuels;

An object of the TRISO particles is to provide comparable reactivity characteristics to standard reference fuel assemblies;

An object of the TRISO particles is to increase the heavy metal mass in the fully ceramic micro-encapsulated fuel pellets;

An object of the fully ceramic micro-encapsulated fuel assembly is to provide compatibility with the standard reference fuel assembly used in current LWRs by matching neutronics thermo-hydraulics operational parameters, such as reactivity coefficients, heat generation, heat transfer and pressure drop.

An object of the fully ceramic micro-encapsulated fuel pellet is to lower initial reactivity using a burnable poison;

An object of the fully ceramic micro-encapsulated fuel pellet and TRISO particles is to slow down and extend the burnup for the fully ceramic micro-encapsulated fuel assembly;

Other advantages of the disclosed fully ceramic micro-encapsulated fuel assembly and fully ceramic micro-encapsulated fuel pellet will be clear to a person of ordinary skill in the art. It should be understood, however, that a system, method, or apparatus could practice the disclosed fully ceramic micro-encapsulated fuel assembly and fully ceramic micro-encapsulated fuel pellet while not achieving all of the enumerated advantages, and that the fully ceramic micro-encapsulated fuel assembly and fully ceramic micro-encapsulated fuel pellet are defined by the claims.

### SUMMARY OF THE DISCLOSURE

12×12 or 13×13 replacement fuel assemblies containing fully ceramic micro-encapsulated (“FCM”) fuel rods that are smaller in number and larger in diameter than conventional solid UO₂ fuel rods in a standard reference fuel assembly are utilized to increase the heavy metal and fissile mass in the FCM fuel pellets, while retaining operational compatibility with the standard reference fuel assembly for light water reactors. Additionally, increased diameter of the kernel of each tristructural-isotropic (“TRISO”) particle in the FCM fuel pellet, and/or the packing fraction of the TRISO particles in the compact and/or the fissile enrichment of the heavy metal also increase the heavy metal and fissile mass in the FCM fuel pellet. A FCM fuel assembly having TRISO particles with kernels comprised of uranium nitride material achieve reactivity characteristics that are comparable to that of a standard solid UO₂ fuel assembly. In one embodiment, the kernel diameter is increased from four hundred micrometers up to eight hundred micrometers. In another embodiment, the enrichment is increased from five percent (5%) up to twenty percent (20%). In yet another embodiment the packing fraction is increased from thirty percent (30%) to forty percent (40%) or fifty percent (50%) or more, up to the allowed limits of the compacting process.

### BRIEF DESCRIPTION OF THE DRAWINGS

The patent or application file contains at least one drawing executed in color.

Copies of this patent or patent application publication with color drawing(s) will be provided by the Office upon request and payment of the necessary fee. Although the characteristic features of this invention will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a graph illustrating the correlation between the k-infinity multiplication factor and burnup for a standard reference fuel and various FCM uranium nitride (“UN”) fuel arrangements in accordance with this disclosure;

FIG. 2A is a graph illustrating the correlation between the k-infinity multiplication factor and burnup for a standard reference fuel and various FCM UN fuel arrangements in accordance with this disclosure;

FIG. 2B is a graph illustrating the correlation between the k-infinity multiplication factor and burnup for a standard reference fuel and various FCM UN fuel arrangements in accordance with this disclosure;

FIG. 2C is a graph illustrating the correlation between the k-infinity multiplication factor and burnup for a standard reference fuel and various FCM UN fuel arrangements in accordance with this disclosure;

FIG. 2D is a graph illustrating the correlation between the k-infinity multiplication factor and burnup for a standard reference fuel and various FCM UN fuel arrangements in accordance with this disclosure;

FIG. 3 is a graph illustrating the correlation between the k-infinity multiplication factor and effective full-power days for a standard reference fuel and various FCM UN fuel arrangements in accordance with this disclosure;

FIG. 4A is a graph illustrating the correlation between the k-infinity multiplication factor and burnup for a standard reference fuel and various FCM uranium oxycarbide (“UCO”) fuel arrangements in accordance with this disclosure;

FIG. 4B is a graph illustrating the correlation between the k-infinity multiplication factor and effective full-power days for a standard reference fuel and various FCM UCO fuel arrangements in accordance with this disclosure;

FIG. 5A is a graph illustrating the correlation between the k-infinity multiplication factor and burnup for a standard reference fuel and various FCM uranium dioxide (“UO₂”) fuel arrangements in accordance with this disclosure;

FIG. 5B is a graph illustrating the correlation between the k-infinity multiplication factor and effective full-power days for a standard reference fuel and various FCM UO₂ fuel arrangements in accordance with this disclosure;

FIG. 6A is a graph illustrating the correlation between the moderator temperature coefficient and burnup for a standard reference fuel and various FCM UN fuel arrangements in accordance with this disclosure;

FIG. 6B is a graph illustrating the correlation between the moderator temperature coefficient and effective full-power days for a standard reference fuel and various FCM UN fuel arrangements in accordance with this disclosure;

FIG. 7A is a graph illustrating the correlation between the moderator temperature coefficient and burnup for a standard reference fuel and various FCM UCO fuel arrangements in accordance with this disclosure;

FIG. 7B is a graph illustrating the correlation between the moderator temperature coefficient and effective full-power days for a standard reference fuel and various FCM UCO fuel arrangements in accordance with this disclosure;

FIG. 8A is a graph illustrating the correlation between the moderator temperature coefficient and burnup for a standard reference fuel and various FCM UO₂ fuel arrangements in accordance with this disclosure;

FIG. 8B is a graph illustrating the correlation between the moderator temperature coefficient and effective full-power days for a standard reference fuel and various FCM UO₂ fuel arrangements in accordance with this disclosure;

FIG. 9A is a graph illustrating the correlation between the fuel temperature coefficient and burnup for a standard reference fuel and various FCM UN fuel arrangements in accordance with this disclosure;

FIG. 9B is a graph illustrating the correlation between the fuel temperature coefficient and effective full-power days for a standard reference fuel and various FCM UN fuel arrangements in accordance with this disclosure;

FIG. 10A is a graph illustrating the correlation between the fuel temperature coefficient and burnup for a standard reference fuel and various FCM UCO fuel arrangements in accordance with this disclosure;

FIG. 10B is a graph illustrating the correlation between the fuel temperature coefficient and effective full-power days for a standard reference fuel and various FCM UCO fuel arrangements in accordance with this disclosure;

FIG. 11A is a graph illustrating the correlation between the fuel temperature coefficient and burnup for a standard reference fuel and various FCM UO₂ fuel arrangements in accordance with this disclosure;

FIG. 11B is a graph illustrating the correlation between the fuel temperature coefficient and effective full-power days for a standard reference fuel and various FCM UO₂ fuel arrangements in accordance with this disclosure;

FIG. 12 is a graph illustrating the correlation between the k-infinity multiplication factor and burnup for a FCM fuel arrangement with different burnable poisons in accordance with this disclosure;

FIG. 13 is a graph illustrating the correlation between the k-infinity multiplication factor and burnup for a standard reference fuel and a FCM fuel arrangement with different types of burnable poisons in accordance with this disclosure;

FIG. 14 is a graph illustrating the correlation between the k-infinity multiplication factor and burnup for a standard reference fuel and a FCM fuel arrangement with different types of burnable poisons in accordance with this disclosure; and

FIG. 15 is a graph illustrating the correlation between the k-infinity multiplication factor and burnup for a standard reference fuel and a FCM fuel arrangement with different types of burnable poisons in accordance with this disclosure.

### DETAILED DESCRIPTION OF THE ILLUSTRATED EMBODIMENT

For an illustrative embodiment of the present teachings, the dimensional differences between a 12×12 FCM fuel pellet and a reference standard 16×16 solid UO₂ fuel pellet are shown in Table 1 below.

| | 16 × 16 | 12 × 12 |
|---|---|---|
| Fuel type | Solid | TRISO in SiC matrix |
| Fuel assembly pitch (cm) | 20.58 | 20.58 |
| Pin pitch (cm) | 1.2863 | 1.715 |
| Fuel pin diameter (cm) | 0.950 | 1.594 |
| Pellet diameter (cm) | 0.819 | 1.451 |
| Gap thickness (cm) | 0.0085 | 0.0085 |
| Clad thickness (cm) | 0.0570 | 0.0630 |

Table 1 shows that the corresponding 12×12 FCM fuel assembly and 16×16 standard fuel assembly have the same fuel assembly pitch while the 12×12 FCM fuel assembly has larger fuel pin and fuel pellet diameters. Accordingly, the volume in the FCM fuel pellet is bigger than that of the reference standard 16×16 solid fuel pellet. The number of rods, disposition and dimensions, including control rod arrangement, are chosen to allow the similar power production in the FCM fuel assembly as in the reference standard fuel assembly and the compatible neutronic and thermohydraulic behavior (including control of reactivity, heat transfer and pressure drop). In one embodiment, the same linear power density and volumetric fissile content is maintained in the FCM fuel assembly as in the reference standard fuel assembly by increasing the diameter of the FCM fuel pins and decreasing their number in the fuel assembly, while keeping the same hydraulic diameter and pressure drop as the reference standard fuel assembly.

Further in accordance with the present teachings, the TRISO particles within the 12×12 FCM fuel pellet have an increased kernel diameter (“KD”) to increase the heavy metal mass in the pellet. The increased KD can be any value from 400 μm to 800 μm. Various cases of increased KD and heavy metal mass in the FCM fuel pellet are listed in Tables 2,3,4 below. All cases are designed to have the same mass of fissile U-235 in the FCM fuel assembly as in the standard solid UO₂ assembly, in order to achieve comparable lifetime operation in the reference reactor core.

TABLE 2
FCM UN fuel

| | | Kernel Diameter | | | |
|---|---|---|---|---|---|
| Packing Fraction | | 400 μm | 500 μm | 600 μm | 700 μm |
| PF = 30% | Case name | PF30KD400 | PF30KD500 | PF30KD600 | PF30KD700 |
| | U235 enrichment | 27.92% | 21.58% | 17.93% | 15.60% |
| | Heavy metal | 1.36533 | 1.76698 | 2.12628 | 2.44235 |
| | mass(gram) | | | | |
| PF = 40% | Case name | PF40KD400 | PF40KD500 | PF40KD600 | PF40KD700 |
| | U235 | 20.94% | 16.18% | 13.45% | 11.70% |
| | enrichment | | | | |
| | Heavy metal | 1.82008 | 2.35518 | 2.83361 | 3.25980 |
| | mass(gram) | | | | |
| PF = 50% | Case name | PF50KD400 | PF50KD500 | PF50KD600 | PF50KD700 |
| | U235 | 16.75% | 12.95% | 10.76% | 9.36% |
| | enrichment | | | | |
| | Heavy metal | 2.27528 | 2.94515 | 3.54399 | 4.07239 |
| | mass(gram) | | | | |

TABLE 3
FCM UCO fuel

| | | Kernel Diameter | | | |
|---|---|---|---|---|---|
| Packing Fraction | | 400 μm | 500 μm | 600 μm | 700 μm |
| PF = 30% | Case name | PF30KD400 | PF30KD500 | PF30KD600 | PF30KD700 |
| | U235 enrichment | 40.10% | 30.99% | 25.75% | 22.40% |
| | Heavy metal | 0.94105 | 1.21798 | 1.46573 | 1.68365 |
| | mass (gram) | | | | |
| PF = 40% | Case name | PF40KD400 | PF40KD500 | PF40KD600 | PF40KD700 |
| | U235 | 30.08% | 23.24% | 19.32% | 16.80% |
| | enrichment | | | | |
| | Heavy metal | 1.25459 | 1.62355 | 1.95343 | 2.24728 |
| | mass (gram) | | | | |
| PF = 50% | Case name | PF50KD400 | PF50KD500 | PF50KD600 | PF50KD700 |
| | U235 | 24.06% | 18.59% | 15.45% | 13.44% |
| | enrichment | | | | |
| | Heavy metal | 1.56846 | 2.03032 | 2.44324 | 2.80756 |
| | mass (gram) | | | | |

TABLE 4
FCM UO₂ fuel

| | | Kernel Diameter | | | |
|---|---|---|---|---|---|
| Packing Fraction | | 400 μm | 500 μm | 600 μm | 700 μm |
| PF = 30% | Case name | PF30KD400 | PF30KD500 | PF30KD600 | PF30KD700 |
| | U235 enrichment | 41.16% | 31.80% | 26.43% | 22.99% |
| | Heavy metal | 0.92515 | 1.19741 | 1.44098 | 1.65523 |
| | mass (gram) | | | | |
| PF = 40% | Case name | PF40KD400 | PF40KD500 | PF40KD600 | PF40KD700 |
| | U235 | 30.87% | 23.85% | 19.82% | 17.24% |
| | enrichment | | | | |
| | Heavy metal | 1.23341 | 1.59614 | 1.92047 | 2.20936 |
| | mass (gram) | | | | |
| PF = 50% | Case name | PF50KD400 | PF50KD500 | PF50KD600 | PF50KD700 |
| | U235 | 24.69% | 19.08% | 15.86% | 13.79% |
| | enrichment | | | | |
| | Heavy metal | 1.54198 | 1.99607 | 2.40202 | 2.76021 |
| | mass (gram) | | | | |

In Tables 2,3,4 above, the fissile materials in the TRISO particles are UN, UCO, and UO₂ respectively. Each case name indicates a packing fraction and a TRISO particle kernel diameter. For example, PF40KD500 indicates a packing fraction of forty percent (40%) and a kernel diameter of 500 μm. As used herein, packing fraction (“PF”) indicates the percentage of the volume of a FCM fuel pellet taken by the TRISO particles. For the cases PF30KD400, PF30KD500 and PF40KD400 of Table 2, PF30KD400, PF30KD500, PF30KD600, PF30KD700, PF40KD400, PF40KD500 and PF50KD400 of Tables 3,4, the U235 enrichment is higher than that of prevalent commercial use, which is below 20 w/o of U235. Accordingly, such cases are not evaluated in the present teachings.

Additionally, as the TRISO particle kernel diameter varies under different cases, the thickness of each other layer of the TRISO particles remains constant, as shown in Table 5 below.

| TRISO fuel particle layer | Parameter | Value | |
|---|---|---|---|
| Kernel | Diameter | Various | |
| | UN density for | 14.32 | g/cc |
| | TRISO with UN | | |
| | material | | |
| Buffer layer | Thickness | 50 | μm |
| | Density | 1.05 | g/cc |
| Inner PyC coating layer | Thickness | 35 | μm |
| | Density | 1.9 | g/cc |
| SiC coating layer | Thickness | 35 | μm |
| | Density | 3.18 | g/cc |
| Outer PyC coating layer | Thickness | 20 | μm |
| | Density | 1.9 | g/cc |

Turning back to Tables 2,3,4, the height of the FCM fuel pellet is assumed to be 1.0 cm. This is a unit length value to perform the calculations and analysis. FCM fuel pellet diameter, height, and other dimensional parameters are indicative, as larger or smaller dimensions can be employed with lower or higher values of enrichment to result in a similar amount of fissile material in the FCM fuel pellet. For the different cases listed in Tables 2,3,4, FCM fuel assembly depletion calculation is performed with McCARD and DeCART codes. McCARD (Monte Carlo Code for Advanced Reactor Design and Analysis) is a Monte Carlo neutron-photon transport simulation code. It estimates neutronics design parameters of a nuclear reactor or a fuel system such as effective multiplication factor. For example, McCARD is suited for performing the reactor fuel burnup analysis with a built-in depletion equation solver based on a matrix exponential method. Similarly, DeCART (Deterministic Core Analysis based on Ray Tracing), a three-dimensional whole-core discrete integral transport code, also performs neutronics calculations.

One result of the FCM fuel assembly depletion calculation is a multiplication factor of the fuel assembly. The multiplication factor (“k”) measures the average number of neutrons from one fission that cause another fission. The remaining neutrons either are absorbed in non-fission reactions or leave the nuclear system without being absorbed. When the value of k is smaller than one (1), the nuclear system cannot sustain a chain reaction because the reaction dies out. Where the value of k is one, each fission causes an average of one more fission, and thus leads to a constant fission level. In one implementation, a 12×12 FCM fuel assembly (“FA”) depletion calculation is performed with the assumptions that the fuel temperature is 900K, the coolant temperature is 600K, and the coolant density is 0.7 g/cc. The calculation results are shown in Table 6 below with packing fractions of 30%, 40% and 50% and kernel diameters of 400, 500, 600 and 700 microns (“μm”). Table 6 shows the values of the effective neutron multiplication factor k and the uranium enrichment required to obtain the factor k for the given packing fraction and kernel diameter in the 12×12 FCM UN fuel assembly.

| | KD = | | | |
|---|---|---|---|---|
| | 400 μm | KD = 500 μm | KD = 600 μm | KD = 700 μm |
| PF = 30% | 27.92% | 21.58% | 17.93% | 15.60% |
| McCARD | 1.62327 | 1.58871 | 1.56184 | 1.53997 |
| DeCART | 1.62421 | 1.59002 | 1.56295 | 1.54107 |
| Diff (pcm) | 35.7 | 51.9 | 45.5 | 46.4 |
| PF = 40% | 20.94% | 16.18% | 13.45% | 11.70% |
| McCARD | 1.58432 | 1.54438 | 1.51186 | 1.48653 |
| DeCART | 1.58590 | 1.54635 | 1.51487 | 1.48922 |
| Diff (pcm) | 62.9 | 82.5 | 131.4 | 121.5 |
| PF = 50% | 16.75% | 12.95% | 10.76% | 9.36% |
| McCARD | 1.55030 | 1.50556 | 1.46967 | 1.44026 |
| DeCART | 1.55267 | 1.50836 | 1.47286 | 1.44397 |
| Diff (pcm) | 98.5 | 123.3 | 147.4 | 178.4 |

As shown in Table 6, the difference between the calculation results from the

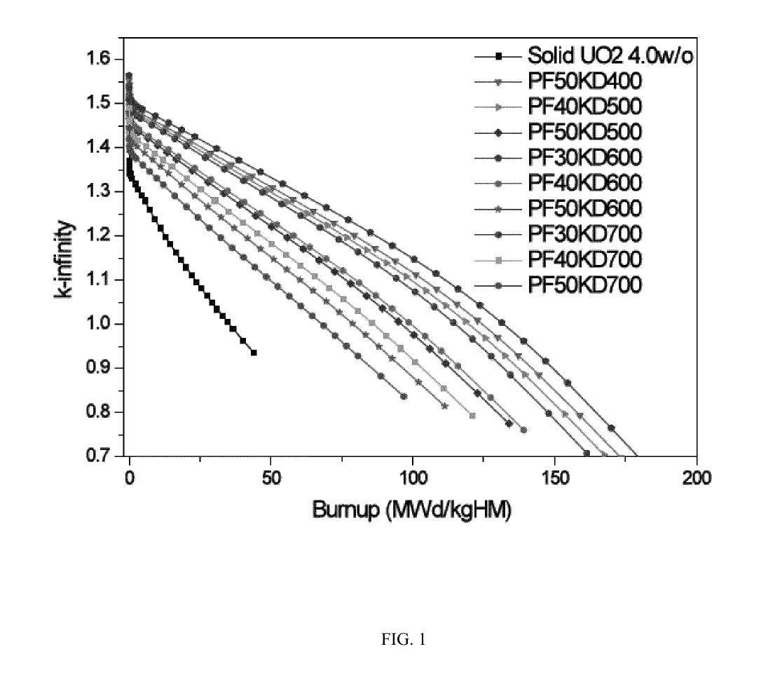

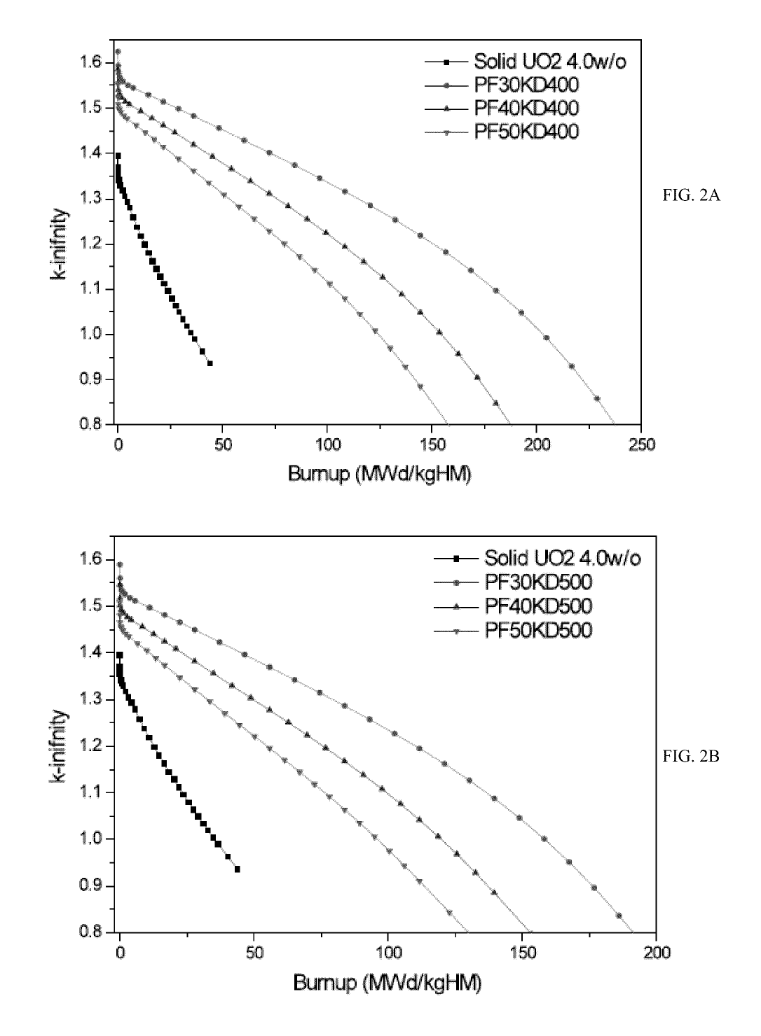

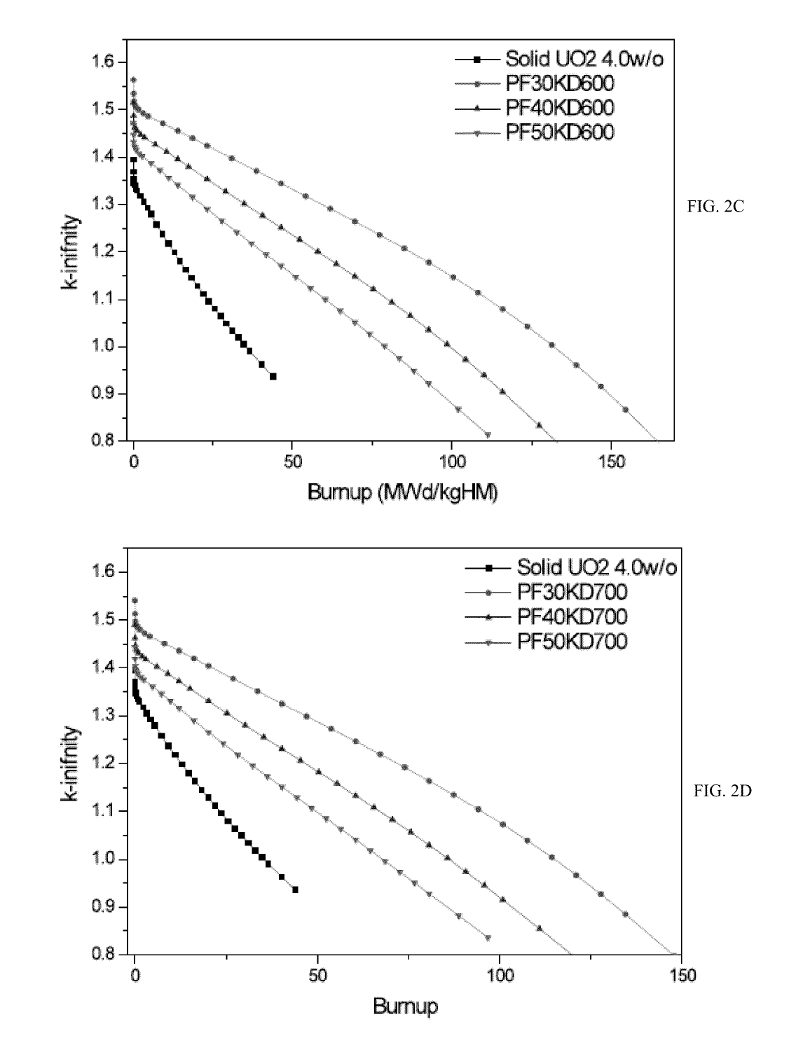

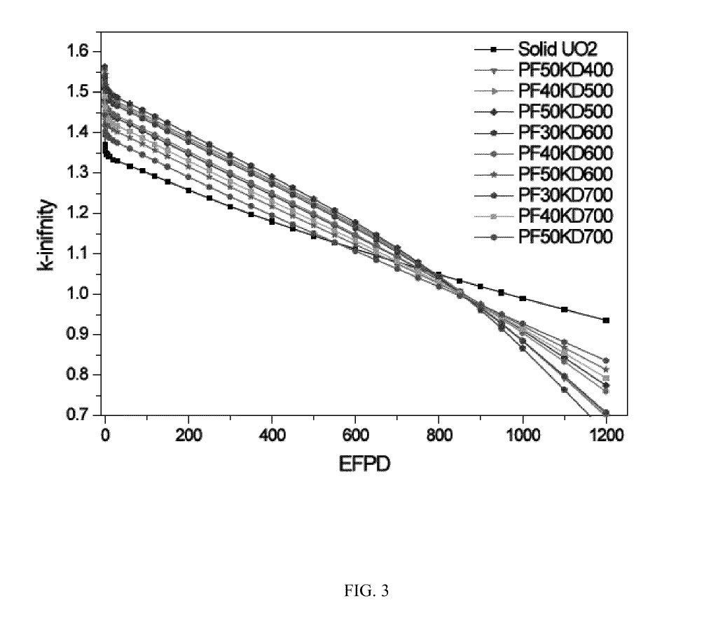

McCARD code and the DeCART code is very small for each case. For example, for the case with PF at 40% and KD at 500 μm, the difference is 82.5 pcm (percent millirho). Accordingly, the DeCART code is used to calculate the multiplication factor and other parameters of the illustrative 12×12 FCM fuel assemblies for further analysis. Calculation results are illustrated by reference to FIG. 1. A correlation between k-infinity and burnup is graphed in FIG. 1 for nine (9) cases of Table 2 and the conventional solid UO₂ fuel. Based on TRISO particle kernel diameter sizes, FIG. 1 is further illustrated as four additional FIGS. 2A, 2B, 2C and 2D. FIGS. 1,2A,2B,2C,2D demonstrate, at a given level of k-infinity, the burnup of each of the FCM UN fuel assembly is closer to or higher than the burnup of a conventional solid UO₂ fuel assembly.

Furthermore, at a given level of k-infinity and a fixed TRISO particle kernel diameter, the rate of fuel burnup bears an inverse correlation with the packing fraction of the FCM fuel pellet. In other words, a higher packing fraction corresponds to a slower fuel burnup. Accordingly, a higher packing fraction (such as 40%) is more desirable than a lower packing fraction (such as 30%) because a longer time to burnup is desirable. Additionally, at a given level of k-infinity and a fixed packing fraction, the fuel burnup rate bears an inverse correlation with the TRISO particle kernel diameter. Therefore, a larger TRISO particle kernel diameter (such as 600 μm) is more desirable than a smaller TRISO particle kernel diameter (such as 400 μm) because a longer time to compete the fuel burnup is desirable. Furthermore, the burnup rate for a FCM UN fuel with a larger TRISO particle kernel diameter is more comparable to the burnup rate for the standard solid UO2 fuel, which is a desirable feature for replacement fuel assemblies.

A correlation between the multiplication factor and effective full-power days (“EFPD”) for each of the ten cases is graphed in FIG. 3. EFPD is a measure of a fuel assembly's energy generation, and is determined as a ratio between the heat generation (planned or actual) in megawatt days thermal (“MWdt”) and licensed thermal power in megawatts thermal (“MWt”). FIG. 3 shows that the correlation between the multiplication factor and EFPD for the different FCM UN fuel assemblies is comparable to that of the conventional solid UO₂ fuel assembly.

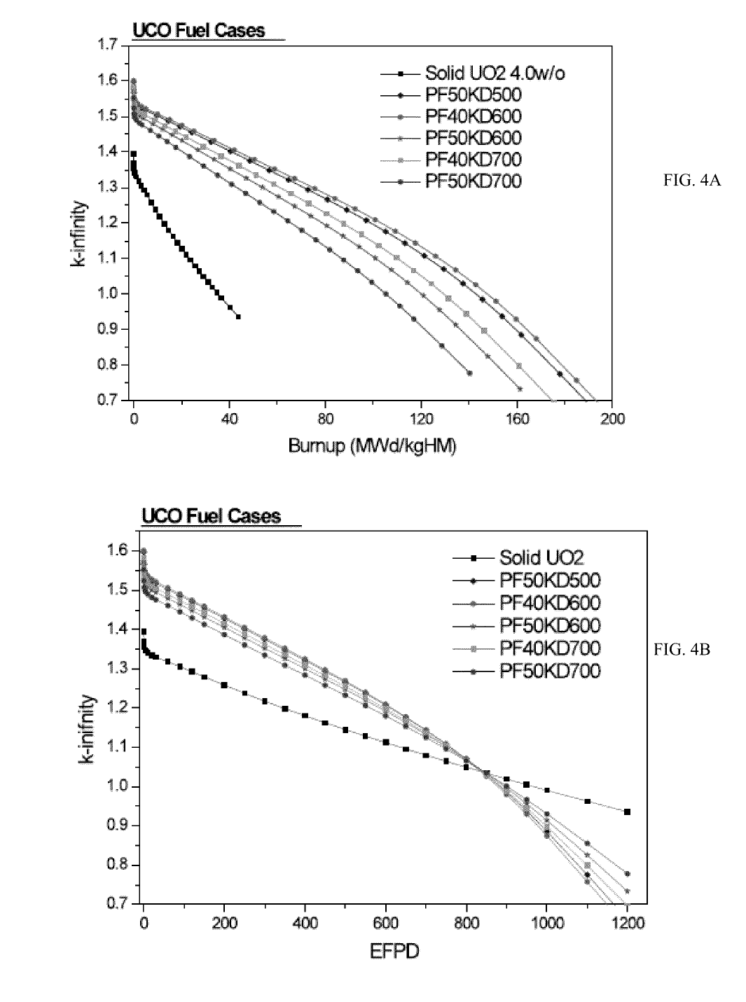

FIG. 4A illustrates the correlation between k-infinity and burnup for five (5) cases of Table 3 and the conventional solid UO₂ fuel. FIG. 4A shows the burnup rates of the FCM UCO fuels are generally higher than that of the FCM UN fuels. For example, where the k-infinity is 1.0, the respective burnups for the FCM UCO fuel and FCM UN fuel of the case PF40KD600, and the solid UO₂ fuel are above 140 (see FIG. 4A), approximately 100 (see FIG. 2C) and approximately 35 (see FIG. 1). In other words, the reactivity characteristics of the FCM UN fuels are more comparable, than that of the FCM UCO fuels, to the reactivity characteristics of the standard UO₂ fuel. Such outcome can also be observed from FIG. 4B. FIG. 4B illustrates a correlation between the multiplication factor and EFPD for each of the six cases referenced in FIG. 4A. For example, where the k-infinity is 1.2, the respective EFPDs for the FCM UCO fuel and FCM UN fuel of the case PF40KD600, and the solid UO₂ fuel are approximately 600 (see FIG. 4B), 500 (see FIGS. 3) and 375 (see FIG. 4B).

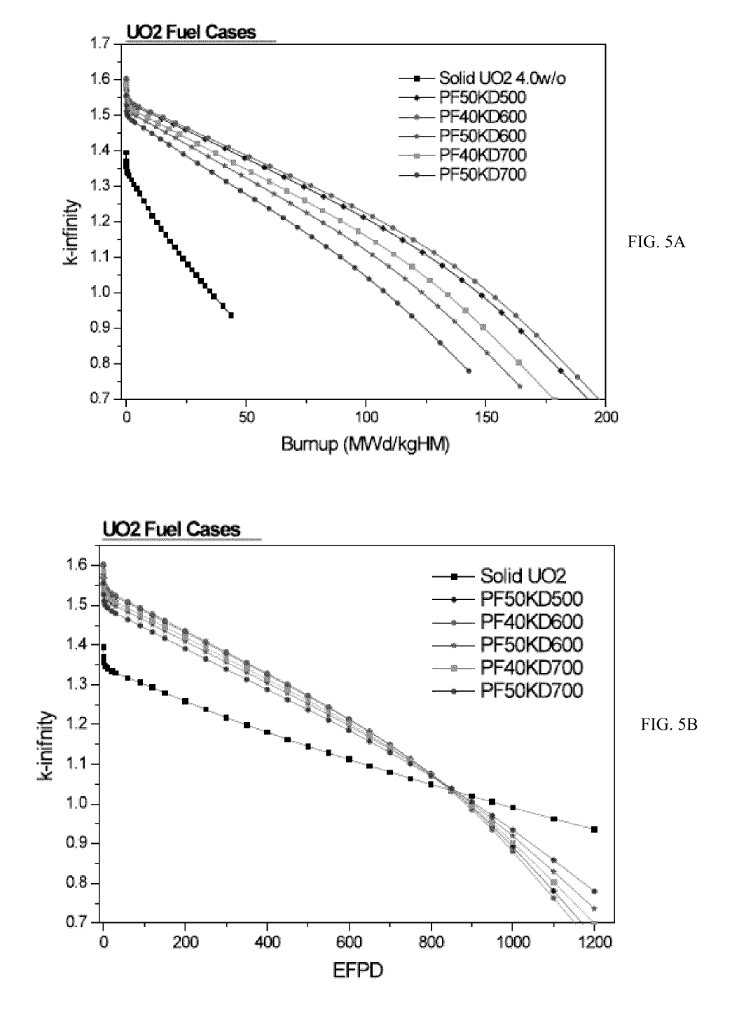

FIG. 5A illustrates the correlation between k-infinity and burnup for five (5) cases of Table 4 and the conventional solid UO₂ fuel. FIG. 5A shows the burnup rates of the FCM UO₂ fuels are generally higher than that of the FCM UN fuels. For example, where the k-infinity is 1.0, the respective burnups for the FCM UO₂ fuel and FCM UN fuel of the case PF40KD600, and the solid UO₂ fuel are approximately 150 (see FIG. 5A), 100 (see FIG. 2C) and approximately 35 (see FIG. 1). In other words, the reactivity characteristics of the FCM UN fuels are more comparable, than that of the FCM UO₂ fuels, to the reactivity characteristics of the standard UO₂ fuel. Such outcome can also be observed from FIG. 5B. FIG. 5B illustrates a correlation between the multiplication factor and EFPD for each of the six cases referenced in FIG. 5A. For example, where the k-infinity is 1.2, the respective EFPDs for the FCM UO₂ fuel and FCM UN fuel of the case PF40KD600, and the solid UO₂ fuel are approximately 600 (see FIG. 5B), 500 (see FIG. 3) and 375 (see FIG. 5B).

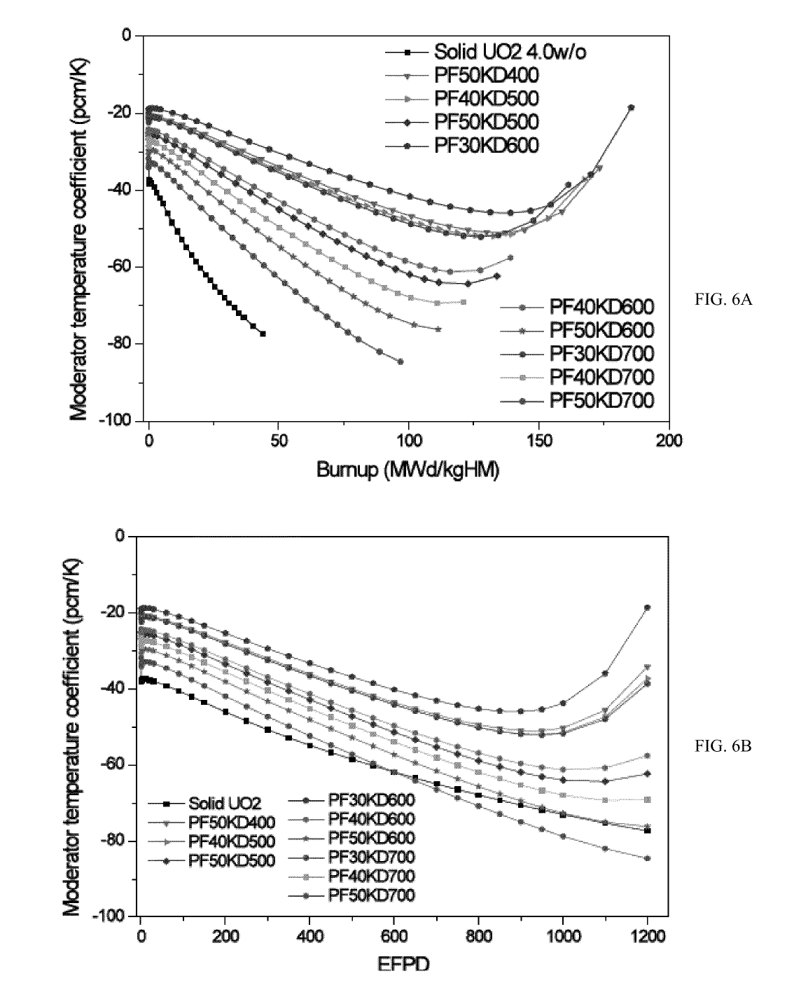

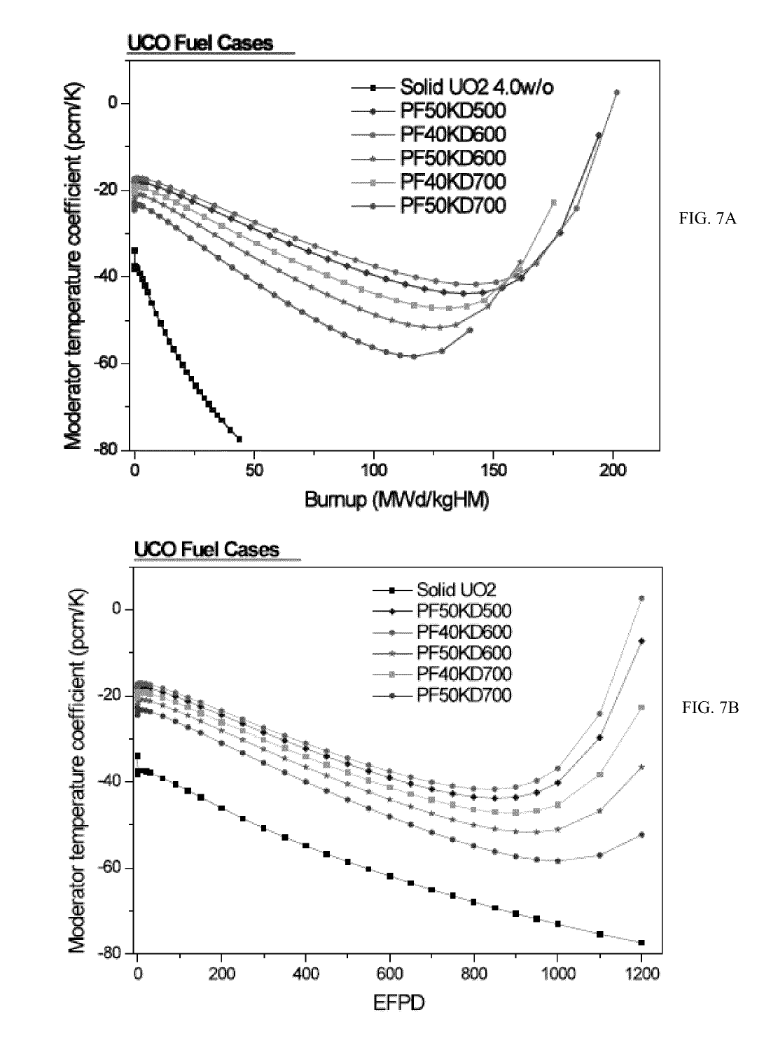

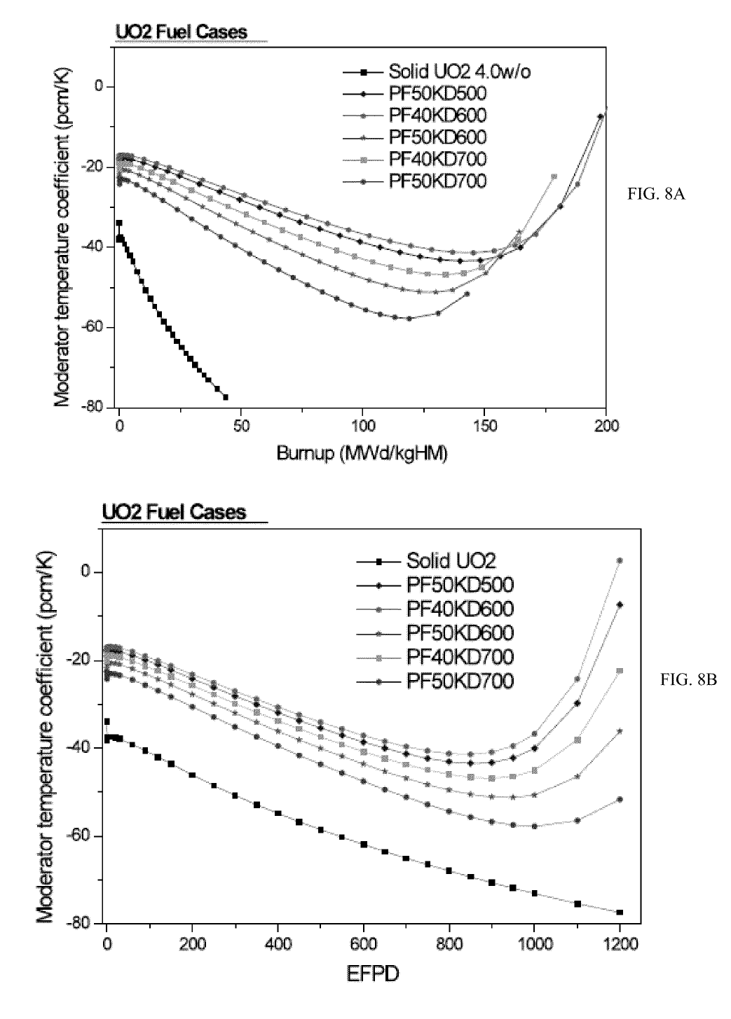

A neutron moderator (such as water) plays a critical role for nuclear reactors. The moderator is a medium that reduces the speed of fast neutrons, and turns them into thermal neutrons capable of sustaining a nuclear chain reaction. As the moderator's temperature increases, it becomes less dense and slows down fewer neutrons, which results in a negative change of reactivity. The change of reactivity per degree change of the moderator temperature is termed as the moderator temperature coefficient (MTC). MTC is an important operational parameter connected with safety considerations. A negative MTC is necessary to reach stability during changes in temperature caused by reactivity. Furthermore, MTC correlates with fuel composition and therefore it will change with fuel burnup. Such correlations are calculated and graphed in FIGS. 6A,6B for nine cases listed in Table 2, FIGS. 7A,7B for five cases listed in Table 3, and FIGS. 8A,8B for five cases listed in Table 4. A graph for the conventional solid UO₂ fuel is also illustrated in each of these figures.

FIGS. 6A,7A,8A show that, at a given level of MTC, the FCM fuels with increased TRISO particle kernel diameter achieve a higher burnup than the conventional solid UO₂ fuel. However, while the MTC for the standard solid UO₂ fuel trends down as burnup increases, the MTC for FCM fuels with smaller fuel loading trends up at higher burnup. Consequently, the MTC for FCM fuels with smaller fuel loading becomes less comparable to the MTC for the standard solid UO₂ fuel. As used herein, fuel loading indicates the level of fissile material in a FCM fuel pellet. Fuel loading bears a direct relationship with packing fraction and TRISO particle kernel diameter. For example, compared to the MTC for the FCM UN fuel of the case PF40KD500, the MTC for the FCM UN fuel of the case PF50KD600 is more comparable to the MTC for the standard solid UO₂ fuel (see FIG. 6A). Accordingly, FCM fuels with smaller fuel loading are less comparable to the conventional solid UO₂ fuel and thus less desirable for replacement in LWRs.

Additionally, the MTCs for the FCM UCO fuels and FCM UO₂ fuels deviate farther from the MTC for the standard UO₂ fuel than the MTCs for the FCM UN fuels do.

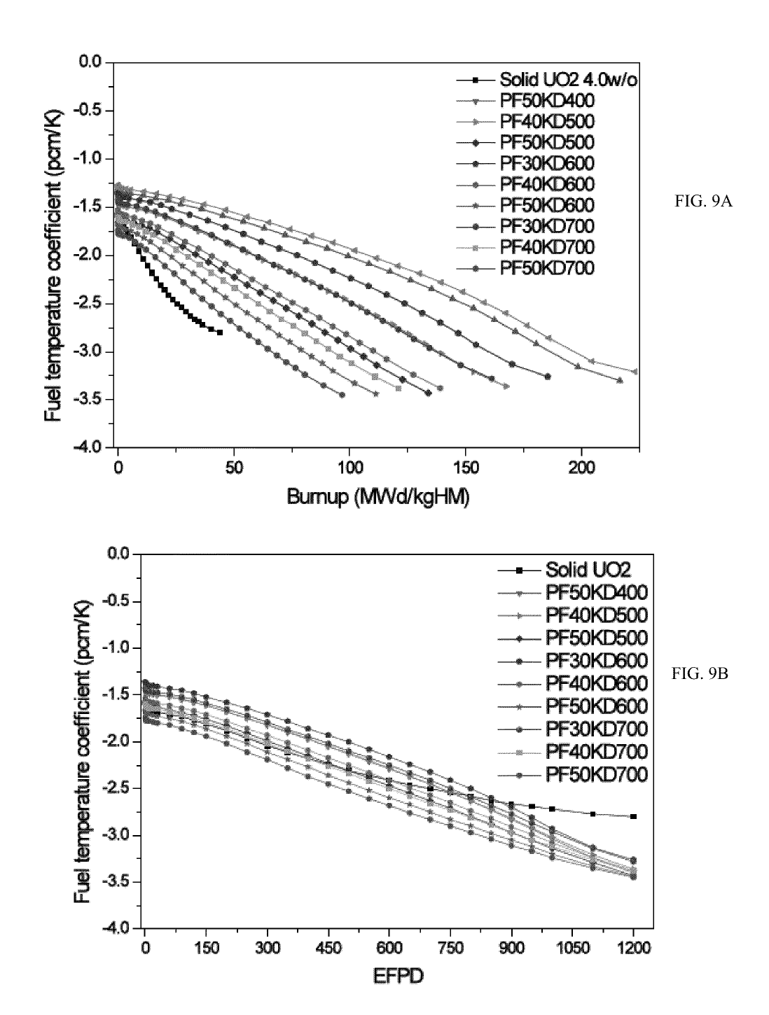

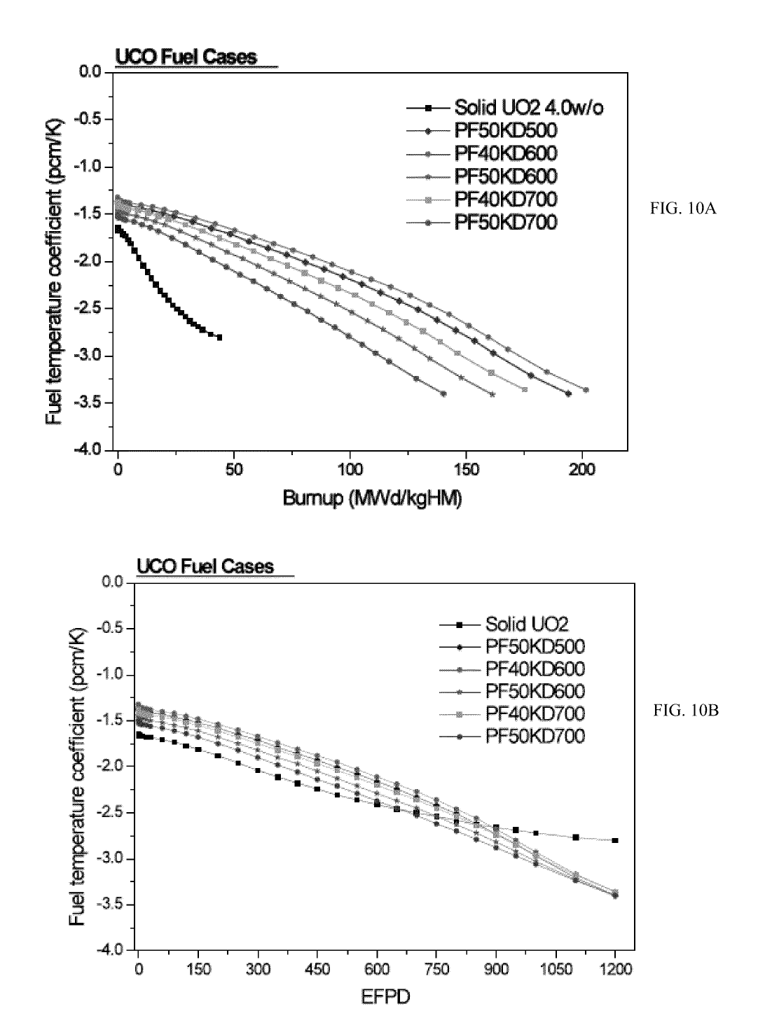

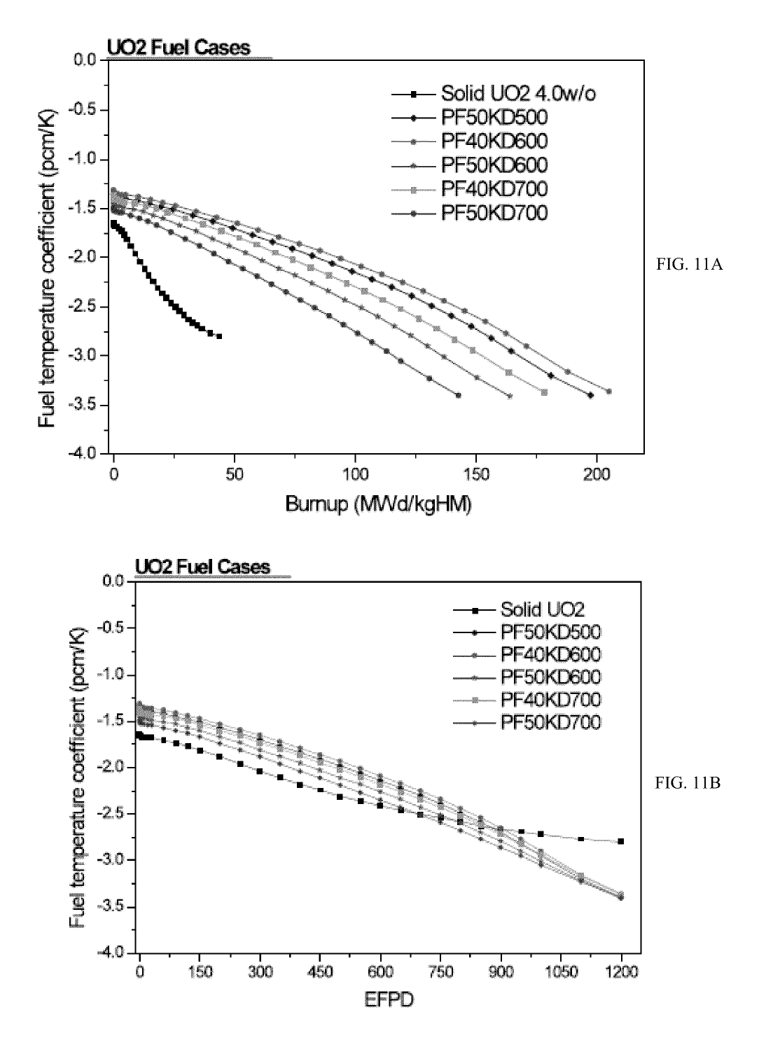

Fuel temperature coefficient (“FTC”) is another temperature coefficient of reactivity. FTC is the change in reactivity per degree change in fuel temperature. FTC quantifies the amount of neutrons that the nuclear fuel absorbs from the fission process as the fuel temperature increases. A negative FTC is generally considered to be even more important than a negative MTC because fuel temperature immediately increases following an increase in reactor power. Moreover, FTC correlates with fuel burnup and EFPD. Such correlations are calculated and graphed in FIGS. 9A,9B for nine cases listed in Table 2, FIGS. 10A,10B for five cases listed in Table 3, and FIGS. 11A,11B for five cases listed in Table 4. A graph for the conventional solid UO₂ fuel is also illustrated in each of these figures.

Similar to the FTC for the conventional solid UO₂ fuel, the FTCs for each of the FCM fuels trends down as burnup increases. However, relative to the FTCs for the FCM UCO fuels and FCM UO₂ fuels, the FTCs for the FCM UN fuels are more comparable to the FTC for the conventional solid UO₂ fuel. For example, where the FTC is −2.5 and the case is PF40KD600, the burnups for the FCM UN fuel, FCM UCO fuel, and FCM UO₂ fuel are approximately 77, 137 and 145 respectively (see FIGS. 9A,10A,11A). Therefore, FCM UN fuels are more comparable to the conventional solid UO₂ fuel and thus more desirable for replacement in LWRs. Additionally, FCM UN fuels with a higher TRISO particle kernel diameter are more comparable to the standard solid UO₂ fuel. For example, where the FTC is −2.5, the burnup for the FCM UN fuel of the case PF40KD600 is approximately 77 and the FCM UN fuel of the case PF40KD500 is approximately 103 (see FIG. 9A).

In nuclear engineering, nuclear fuel exhibits high reactivity when initially loaded, particularly the higher enrichment FCM fuel, as higher enrichment is required by the use of TRISO particles in the inert SiC matrix, with respect to the reference standard solid oxide fuel. A neutron poison, which is a substance with a large neutron absorption cross section, is sometimes inserted into a reactor core to lower such high reactivity. Burnable poisons are special types of neutron poisons that are converted into materials of relatively low absorption cross section. Ideally, burnable poisons decrease their negative reactivity at the same rate at which the FCM fuel's excessive positive reactivity is depleted. A burnable poison, such as Gd₂O₃ and Er₂O₃, can be used in the form of a sintered mixture with the SiC matrix material or BISO particles. Each BISO particle has a kernel inside layers of coating materials, including an outer ceramic coating. BISO particles are utilized by placing them in a ceramic matrix that is composed of the same material as the BISO particles' outer ceramic coating. Volume fraction is a parameter of BISO particles, which is defined as (1−p), wherein p stands for the porosity of the outer ceramic coating material.

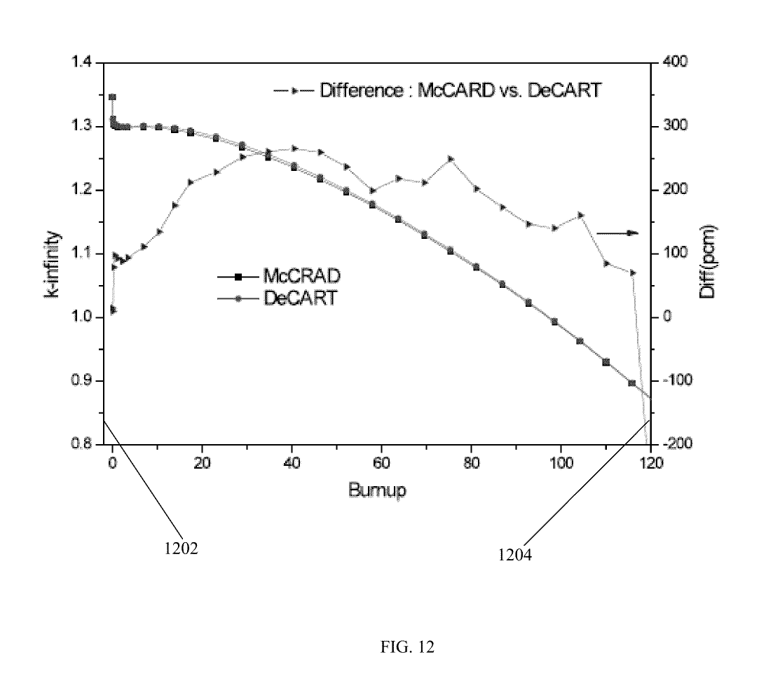

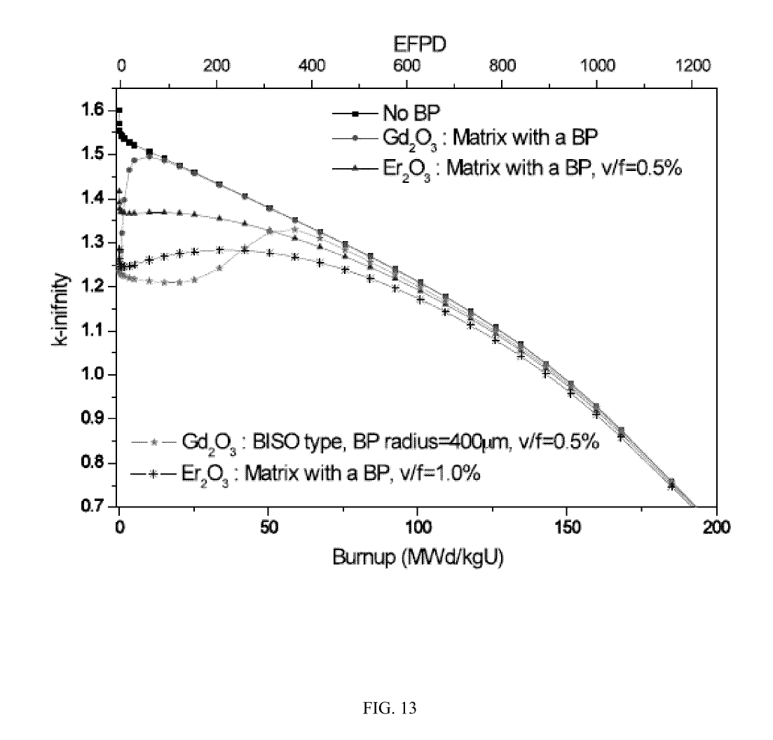

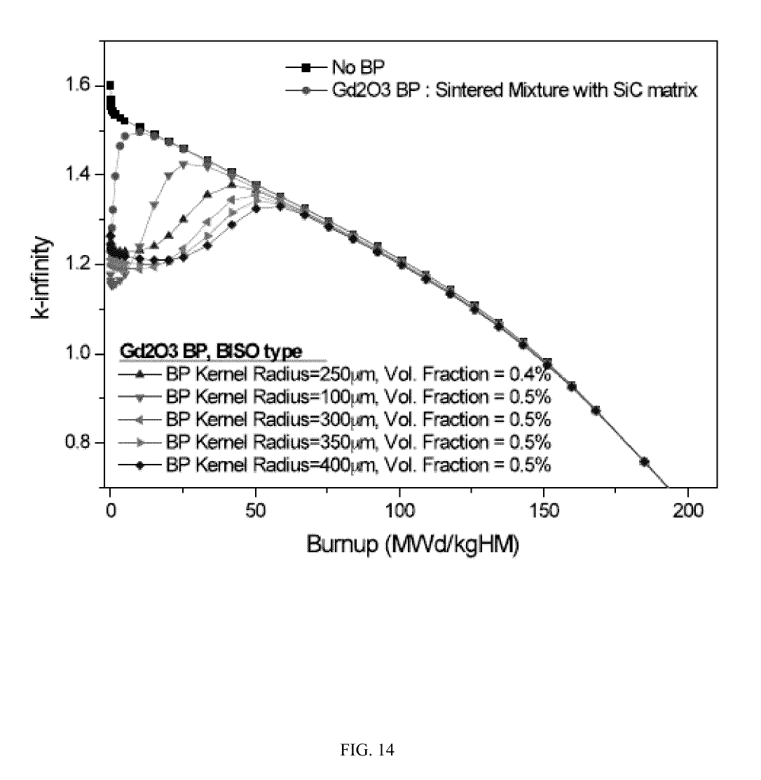

The characteristics of a fuel assembly with a burnable poison can be evaluated using McCARD and DeCART codes. As shown by FIG. 12, the difference between the McCARD and DeCART codes is relatively small. Accordingly, the DeCART code is used for further analysis of burnable poisons as shown in FIGS. 13,14,15.

The correlation between k-infinity and fuel burnup for a 12×12 FCM UCO fuel assembly with burnable poisons is shown in FIGS. 13,14,15. As shown in FIG. 13, the burnable poisons are Gd₂O₃ with SiC matrix, Er₂O₃ with SiC matrix having a volume fraction (“v/f”) of 0.5%, Gd₂O₃ of BISO type with a kernel radius of 400 μm and a v/f of 0.5%, and Er₂O₃ with SiC matrix having a v/f of 1.0% respectively. Additionally, the 12×12 FCM UCO fuel has a packing fraction of 40% and a TRISO particle kernel diameter of 600 μm. FIG. 13 indicates that the Gd₂O₃ burnable poison is more rapidly burned out than the Er₂O₃ burnable poison. Accordingly, the Er₂O₃ burnable poison is a more desirable burnable poison for FCM fuels used for LWRs.

In FIG. 14, the burnable poisons are Gd₂O₃ with SiC matrix and Gd₂O₃ of BISO type with kernel radius of 250 μm, 100 μm, 300 μm, 350 μm and 400 μm. The corresponding v/f for the Gd₂O₃ of BISO type are 0.4%, 0.5%, 0.5%, 0.5% and 0.5% respectively. FIG. 14 indicates that, at a certain level of k-infinity, the burnup rate of the Gd₂O₃ of BISO type burnable poison varies with the kernel radius.

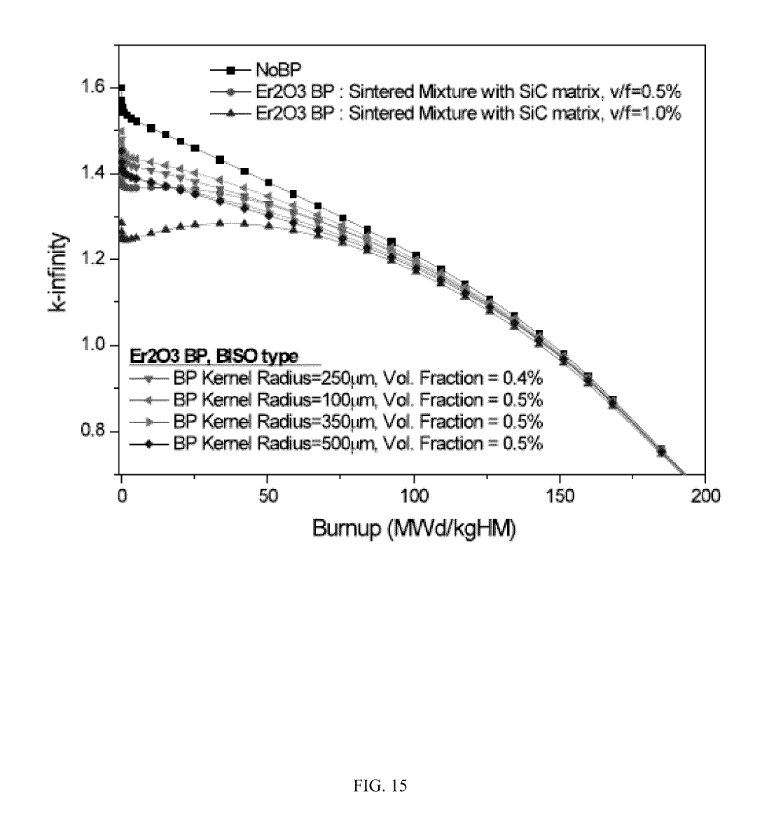

In FIG. 15, the burnable poisons are Er₂O₃ with SiC matrix having v/f of 0.5% and 1.0%, and Er₂O₃ of BISO type with kernel radius of 250 μm, 100 μm, 350 μm and 500 μm. The corresponding volume fractions for the Er₂O₃ of BISO type are 0.4%, 0.5%, 0.5% and 0.5% respectively. FIG. 15 indicates that, at a certain level of k-infinity, the burnup rate of the Er₂O₃ of BISO type burnable poison varies with the volume fraction. In other words, the correlation between k-infinity and fuel burnup for FCM fuels with Er₂O₃ of BISO type varies with v/f the Er₂O₃ burnable poisons. However, in such cases, the variation of kernel radius has minimum effect on the correlation between k-infinity and fuel burnup. From the results of the burnable poison analysis, it notes that the Er₂O₃ burnable poison is better than Gd₂O₃ burnable poison in case of the fuel loading aspects. In the sintered mixture case, the fuel loading is not affected by burnable poison loading, but the fuel loading can be affected by burnable poison loading in the case of BISO type burnable poison.

Obviously, many additional modifications and variations of the present disclosure are possible in light of the above teachings. Thus, it is to be understood that, within the scope of the appended claims, the disclosure may be practiced otherwise than is specifically described above. For example, the disclosure may be practiced for 13×13 FCM fuel assemblies.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It is intended that the scope of the disclosure not be limited by the specification, but be defined by the claims set forth below.

What is claimed is:

1. A fully ceramic micro-encapsulated (“FCM”) fuel pellet for a nuclear reactor comprising:
a plurality of tristructural-isotropic (“TRISO”) particles wherein a kernel of each TRISO particle of the plurality of TRISO particles is comprised of uranium nitride wherein a diameter of the kernel is larger than three hundred ninety nine micrometers, and wherein the FCM fuel pellet is disposed within a FCM fuel assembly.

2. The FCM fuel pellet of claim 1 wherein the FCM pellet has a packing fraction that is larger than twenty nine percent.

3. The FCM fuel pellet of claim 2 wherein the packing fraction is larger than thirty nine percent and smaller than forty one percent,

4. The FCM fuel pellet of claim 1 wherein the kernel diameter is larger than four hundred ninety micrometers and smaller than eight hundred ten micrometers.

5. The FCM fuel pellet of claim 1 wherein the FCM fuel assembly is comprised of a set of FCM fuel rods bundled in a square matrix arrangement wherein the horizontal dimension of the square matrix is twelve.

6. The FCM fuel pellet of claim 1 wherein the FCM fuel assembly is comprised of a set of FCM fuel rods bundled in a square matrix arrangement wherein the horizontal dimension of the square matrix is thirteen.

7. The FCM fuel pellet of claim 1 wherein the FCM fuel pellet is comprised of TRISO particles and burnable poison material dispersed in a sintered matrix as oxide.

8. The FCM fuel pellet of claim 7 wherein the burnable poison material is Er₂O₃.

9. The FCM fuel pellet of claim 1 wherein the nuclear reactor is a light water reactor.
